(19) United States
(12) Patent Application Publication
(10) Pub. No.: US 2011/0174194 A1
(43) Pub. Date: Jul. 21, 2011

(54) PUMPABLE CEMENTITIOUS GROUT SYSTEM FOR USE IN THE PRODUCTION OF UNDERGROUND ROOF-SUPPORT SYSTEMS AND OTHER LOAD-BEARING STRUCTURES

(76) Inventor: Duncan Hird, Owston Ferry (GB)

(21) Appl. No.: 12/920,759

(22) PCT Filed: Mar. 6, 2008
(86) PCT No.: PCT/US08/56046

§ 371 Date: Apr. 1, 2011

(51) Int. Cl. C04B 28/04

(52) U.S. Cl. 106/639; 106/705; 137/550

(57) ABSTRACT

A pumpable grout mixture includes a first grout stream including a hydraulically active cementitious material suitable for cementing in underground applications and water, and a second grout stream including a pozzalanic material and an inorganic gelling agent wherein the two grout streams are combined into a grout mixture to form a self-supporting load bearing structure.

### BACKGROUND OF THE INVENTION

1. Field of the Invention

This invention relates to the provision of a secondary support system in underground mining operations, and in particular, to providing a roof support system which allows the safe and efficient operation of the mine. The invention provides a cost effective means of installing roof-support systems, particularly with reference to the needs of the coal-mining industry, by utilizing materials available within the United States of America (USA).

2. Description of the Prior Art

Several forms of secondary roof support are currently available, such as traditional timber or steel props, lightweight concrete blocks, and cylindrical metal molds filled with foamed lightweight concrete. Currently, cylindrical metal molds of lightweight concrete are probably the most widely used support system in the USA.

Whilst all these systems are capable of providing adequate support, there are a number of inherent difficulties associated with their installation and effectiveness. These types of support are prefabricated prior to installation, and a considerable degree of underground manual handling (and its associated safety risks) is required in their installation. Prefabricated supports can be difficult to install in areas that are inaccessible to mechanical transport systems or in other areas of restricted access. Considerable manpower is required to install these systems and material bottlenecks, particularly where access may be limited, can lead to delays. Difficulties can also be experienced in obtaining good, even contact between the support and the roof and/or floor of the mine. Point contact loading between the support and the roof reduces the effectiveness of the support. To overcome this problem, wooden packing is frequently used as a spacer between the support and the roof. However, the use of wooden wedges to achieve even contact with the roof also significantly reduces the stiffness of the support since the wood is effectively in series with the main support material.

An alternative method that has come into frequent use is that of pumpable secondary roof supports. This method does not rely on the prefabrication of supports prior to transporting and installing them underground and overcomes many of the difficulties associated with the other forms of support described above. The support materials, in the form of water based slurries referred to as grouts, are pumped from a remote location, generally, but not always, above ground, to the area of the mine where roof support is required (i.e. the point of application).

The grouts are pumped into a cylindrical, impermeable, flexible bag referred to as a crib bag. Initially, the bag acts as a form to contain the grout whilst the support is being formed. It also has a secondary function in providing sufficient containment for the hardened grout as it comes under increasing load from the overlying roof strata and begins to fracture. Typically the bag is made of polyester, woven in such a way as to provide enhanced tensile strength. It may also be provided with reinforcing wire installed in a spiral, or other pattern, around the length of the bag. A range of bag sizes may be used depending upon the particular requirements of the duty required. Commonly, bags 6 to 8 feet in length and 24, 27 or 30 inches in diameter are used. It is usual for the crib bag to be supported by a set of plastic “pogo sticks”; these are extendable plastic poles, designed to suspend the crib bag between the floor and roof of the mine or underground workings. Alternatively, the crib bag may be suspended from the roof of the workings. Two slurries are combined, by means of a “Y” piece, a few feet prior to entering the crib bag. The crib bag has an attachment close to the top where the combined slurries can enter. It also has a “bleed pipe” attached at the top to ensure that the crib bag is totally filled with the combined slurries. It is normal to fill two or more crib bags in the same operation, each bag being partially filled in turn. This operation being referred to as filling the crib bags by a series of lifts. Three lifts are generally taken to completely fill each crib bag.

A cementitious component and an activator component are used in the construction of this type of roof support. Typically, a water based grout of each component is produced separately in mixing tanks with paddle attachments. These are then drawn, via a filter unit, into a double acting positive displacement pump. The grouts pass down separate delivery lines, approximately 1.25 inches in diameter, until just prior to the point of entry to the bag. Pipelines of this diameter are easily handled both above and below ground. At this stage they are combined, via the “Y” piece, into a single product stream and upon mixing begin to react and form a gel. The reaction between the cement grout and the activator grout is sufficiently rapid to allow the formation of a self-supporting column of material in the bag, normally, within ten to fifteen minutes. The mix then continues to gradually harden completely to form a cylindrical support column, referred to within the art as a crib support.

A schematic representation of this system is shown in FIG. 1. This method of construction ensures good contact with the roof and floor of the mine and eliminates the need for secondary materials, e.g. wooden wedges, to be installed to establish proper roof contact. Pumpable roof supports minimize the need to handle materials underground, thereby reducing the risk of injuries historically associated with in-mine support construction. Pumping distances can be in excess of 3,000 yards and the system provides a speedy and efficient means of installing roof supports. Typically, a crew of seven men, four underground at the installation site and three at the pumping station, can install forty or fifty crib supports per shift.

Currently, the most commonly used material in the production of pumpable roof supports is calcium sulfo-aluminate cement (CSA cement), together with an appropriate activator. The key component of this type of cement is the compound Ca₄Al₆(SO₄)O₁₂, also known as Kleins compound. When activated by the presence of calcium sulfate, lime and other minor components, it gels, sets and develops strength very rapidly. This is attributable to the rapid formation of the mineral ettringite—3CaO.Al₂O₃.3CaSO₄.32H₂O, when, in the presence of water, the cement and activator, are brought together. In practice, CSA cement and water form one grout stream, and calcium sulfate, lime etc. and water form a second grout stream.

Due to the quantity of water required for the successful conversion of Kleins compound into ettringite, CSA cements exhibit a high water demand, considerably higher than that for other types of cement. This is illustrated by the amount of water of crystallization contained in the mineral; the ettringite retaining all the water required for hydration as water of crystallization. In practice, there must be sufficient water incorporated in the system not only to satisfy the hydration requirements of the cement and activator, but also to produce a workable mobile slurry mix of each component, such that they can be successfully pumped simultaneously to the point of application. The high water demand exhibited by CSA cement systems is obviously advantageous in its use in pumpable roof supports since water:solids ratios in CSA cement based grouts produced for roof support systems can be as high as 2.50:1. These grouts can be pumped for distances well in excess of 12,000 feet since it produces, in its un-activated state, a grout that is highly mobile and easily pumpable. Virtually all of the water used in producing the grouts is retained in the hardened structure.

Pumpable supports have also been produced, although to a lesser extent than CSA cement based systems, using high alumina cements (HA cements). These cements tend to be highly reactive and can generate high early compressive strengths. HA cement can produce compressive strengths at 24 hours comparable to that produced by ordinary Portland cement after 28 days. The setting and strength development in these cements does not derive from the production of ettringite, but from the hydration of calcium aluminates. The active components are mono-calcium aluminate CaO.Al₂O₃ and Mayenite (12CaO.7Al₂O₃). A number of meta-stable phases are passed through during the hydration process but the final hydration phases may be described as 3CaO.Al₂O₃.6H₂O together with Al(OH)₃ gel, plus water. HA cement grouts have been successfully used at water:cement ratios as high as 2.5:1

As indicated above, factors other than the amount of water required for hydration have to be taken into account to produce a CSA or HA cement grout that is both pumpable and capable of performing its prime duty of providing a satisfactory support system. These are generally associated with the particular characteristics of the type of cement and activator system being used and the need to transport and place the grout at distant locations. Thus, the physical and chemical characteristics of the cement system being used may have a limiting influence on the distance over which the grout may be pumped and/or its gelling/setting behavior; for example, it may be necessary in cold conditions to use heated water in the grout to speed up the hydration reaction and shorten gelling/setting times. Conversely, a retarder may be added to delay gelling thereby lengthening the distance over which the slurry can be pumped.

The particular hydration characteristics of CSA and HA cement systems and their rapid gelling/setting properties are particularly beneficial to their successful use in underground support systems, enabling a high water content, rapid gelling/setting, but pumpable grout to be produced. However, the cost of using these cements in underground support systems (or in other applications) is high. The raw materials used to produce HA and CSA cements are generally more expensive than those used in the manufacture of ordinary Portland cements. There is a limited market for such cements and the volumes used are generally felt to be insufficient for a major cement manufacturer to convert from the production of conventional ordinary Portland cement to CSA/HA cement production. Consequently, CSA cement and the grades of HA cements used in mining applications are imported into the USA, either as finished cement, or as cement clinker (which is then ground into cement within the USA), further contributing to the high cost of these cements.

However, difficulties associated with producing a pumpable grout which gels and sets rapidly, retains the water used in its production, but still produces a column of sufficient strength to provide adequate support, has hitherto constrained the use of ordinary Portland cements in the production of pumped roof support systems. The use of a system based upon ordinary Portland cement would, however, provide a lower cost option for pumpable roof support systems as compared to those systems utilizing the CSA and HA cement described above.

### SUMMARY OF THE INVENTION

It is an object of this invention to provide a lower cost system of installing roof supports in underground situations. It is a further object to utilize ordinary Portland cements, together with a pozzalanic component and gelling agent to produce the support. It is also an object to utilize the above materials in the form of a water based grout that can be pumped, utilizing the existing mixing and pumping facilities currently used for such installations, into the impermeable cylindrical shaped molds known as crib bags already in use for the installation of roof supports. It is another object to provide a physical means of ensuring that maximum pumping distances are achieved by the use of a filter and mixing chamber in the pump-feed line. It is a further object that the completed support should conform to the general requirements for roof support systems of the mining industry and in particular the coal-mining industry.

According to the present invention, a pumpable grout mixture includes a first grout stream including a hydraulically active cementitious material suitable for cementing in underground applications and water and a second grout stream including a pozzalanic material and an inorganic gelling agent and water, wherein the two grout streams are combined into a grout mixture to form a self-supporting load bearing structure.

According to another aspect of the invention, a filter and mixing box apparatus, includes a polygonal box shaped container, an inlet port disposed on a first side of the container, an exit port disposed on a second side of the container, a mesh screen disposed in an interior of said container in an area between said inlet port and said exit port, a base disposed in the interior of the container, having an inclined surface extending from the first side to the second side of the container, wherein an upper portion of the inclined surface is disposed near the first side and the lower portion of the inclined surface is disposed near the second side, and triangular fillets are disposed in two corners of the interior of the container, so as to form obtuse angled corners in the interior of the container.

Furthermore, another aspect of the invention includes a method of providing a pumpable grout for use in load bearing structures, including providing a first pumpable grout stream composed of an ordinary Portland cement and water, providing a second pumpable grout stream containing PFA and an inorganic gelling agent and water, transporting each of the first and second pumpable grout streams separately and simultaneously along separate pipelines; conveying each of the first and second pumpable grout streams separately and simultaneously into a first and second filter/mixing chamber, respectively, transporting each of the first and second pumpable grout streams separately and simultaneously into a double-action positive displacement pump, which pumps each of the first and second pumpable grout streams to a point of application wherein the separate grout streams are combined into a combined grout mixture. An overall water-to-solids ratio of the combined grout mixture is between 1:1 and 1:2 by weight and the ratio of Portland cement to PFA lying between 1:1 and 1:2, and the gelling agent is 1%-8% by weight of the combined grout mixture.

### BRIEF DESCRIPTION OF DRAWINGS

The above and/or other aspects and advantages of the present invention will become apparent and more readily appreciated from the following description of the embodiments, taken in conjunction with the accompanying drawings of which:

FIG. 1 is a schematic flow diagram illustrating the production of a mine roof support using a two component pumpable grout system;

FIG. 2A illustrates a plan view of the design of the combined filter/mixing chamber of an exemplary embodiment of the invention;

FIG. 2B illustrates a cross-sectional view taken along section I-I of FIG. 2A;

FIG. 2C illustrates a cross-sectional view taken along section II-II of FIG. 2A;

FIG. 2D illustrates a cross-sectional view taken along section of FIG. 2A;

FIG. 2E illustrates a cross-sectional view taken along section IV-IV of FIG. 2D; and

FIG. 2F illustrates a cross-sectional view taken along section V-V of FIG. 2D.

### DESCRIPTION OF EXEMPLARY EMBODIMENTS OF THE INVENTION

Reference will now be made in detail to the exemplary embodiments of the present invention, examples of which are illustrated in the accompanying drawings, wherein like reference numerals refer to like elements throughout.

According to an exemplary embodiment of the invention, two water-based pumpable grouts are prepared. The first grout comprises a hydraulically active cementitious component, such as a suspension of ordinary Portland cement. The second grout comprises a suspension of a pozzolan material plus a suitable activator/gelling agent. Portland cements are classified by the American Society of Testing Materials (ASTM) in ASTM C150 into five major types identified by Roman numerals I, II, III, IV and V. Types I, II and III may also be produced incorporating an air-entrainer. They are then designated as Ia, IIa and Ma. Although the following exemplary embodiments utilize Types I and II, other classes of ordinary Portland cement may be used if suitable adjustments are made to maintain the performance of the completed installation. Alternatively, other types of cement may be selected to produce a support material designed for a specific duty or purpose.

Ordinary Portland cements derive their properties from the hydration of tri-calcium silicate (CaO)₃.SiO₂ and di-calcium silicate (CaO)₂.SiO₂; these two compounds accounting for over 70% of their composition. The hydration reaction may be considered to produce 3CaO.2SiO₂.3H₂O together with calcium hydroxide, Ca(OH)₂. The calcium hydroxide formed then being available for reaction with supplementary materials such as pozzolans.

The second pumpable grout is comprised of a pozzalan material, activator and water. The second pumpable grout may be a suspension of pulverized fuel ash (PFA) (as the pozzalan material) together with an activator/gelling agent. Pulverized fuel ashes are materials extracted by electrostatic and mechanical means from the flue gases of power-station furnaces fired with pulverized bituminous coal. PFA consists essentially of reactive silicon and aluminum oxides (SiO₂ and Al₂O₃) It has a high glassy silica content but a low lime (CaO) content and will thus not react on its own with water but needs a source of calcium hydroxide Ca(OH)₂ before any hydrates can be formed, i.e. it is pozzalanic rather than hydraulic. Ordinary Portland cement, via its normal hydration process is usually used to provide the necessary calcium hydroxide for the reaction with the PFA.

Due to the high water content of the ordinary Portland cement slurry, which is required to enable it to be pumped easily over long distances, its slow setting time is counteracted by adding a gelling agent. In particular, a gelling agent is incorporated into the PFA slurry. The gelling agent may be an alkali metal aluminate, alkali metal carbonate, aluminum sulfate, sodium silicate or other suitable compounds. The amount of gelling agent incorporated into the system is preferably sufficient to result in the combined grout mixtures forming a self-supporting gel within fifteen minutes. Gelling agent addition rates of 4% to 25%, as a percentage by weight of the cement fraction of the grout, were found to be the most effective. Preferred gelling agents are sodium aluminate (35-40% solution) or aluminum sulfate.

The invention does not require any major modifications to the mixing and pumping equipment which would normally be used in the installation of pumped roof-support systems utilizing CSA or HA cements. Generally, two water based grout streams 10, 20 are pumped along separate pipelines until close to the point of entering a flexible cylindrical shaped mold 7, referred to in the art as a crib bag, the mold spanning the gap between the floor and roof of the underground operation. At this point, the two grout streams 10, 20 are combined, via a “Y” piece 6, into a single flow of grout material (grout stream) 30. Upon mixing, the two grout mixtures rapidly gel under the influence of the activator and shortly after entering the mold the combined mixture becomes self-supporting. Pumping continues until the mold 7 is completely filled. The mixture then continues to set and harden, ultimately being capable of providing support for the overlying rock strata.

With the grout mixture of the present invention, the use of existing mixing and pumping systems for the installation of crib supports may be utilized; however, since the inventive mixture utilizes a lower water-solids ratio than that employed in conventional CSA or HA cement based systems, a specially designed novel filter and mixing chamber may be incorporated into the existing systems, in order to maximize the distance over which the lower water-solids ratio grouts may be pumped. This novel filter and mixing chamber is described in further detail later.

Proper mixing is important in order to prevent blockages from occurring in the pumping system, since blockages cause delays in the installation of crib supports. In underground use, significant blockages can lead to the abandonment of pumping lines. Thus, while retaining the advantages of pumpable roof supports produced from CSA or HA cements described earlier, the present invention provides for the use of slurries having a lower water content with ordinary Portland cements and pozzalanic materials which are readily and inexpensively available, as an alternative to these CSA and HA cement systems.

According to the present invention, the two pumpable grouts 10, 20 are produced separately in a pair of mixing tanks 4a, 4b, of approximately 90 gallons capacity each, with paddle attachments. Once the grouts have been mixed, they are drawn separately and simultaneously via pipelines and transported through respective combined secondary mixing and filter chambers 100a, 100b which are novel to the present invention.

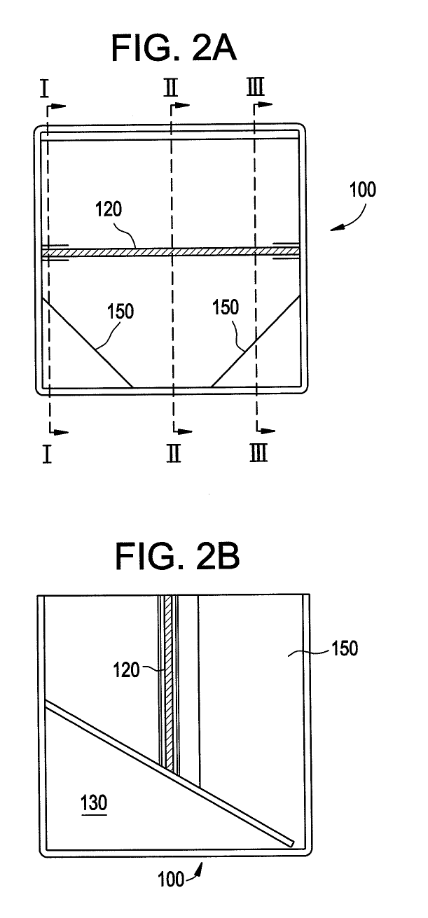

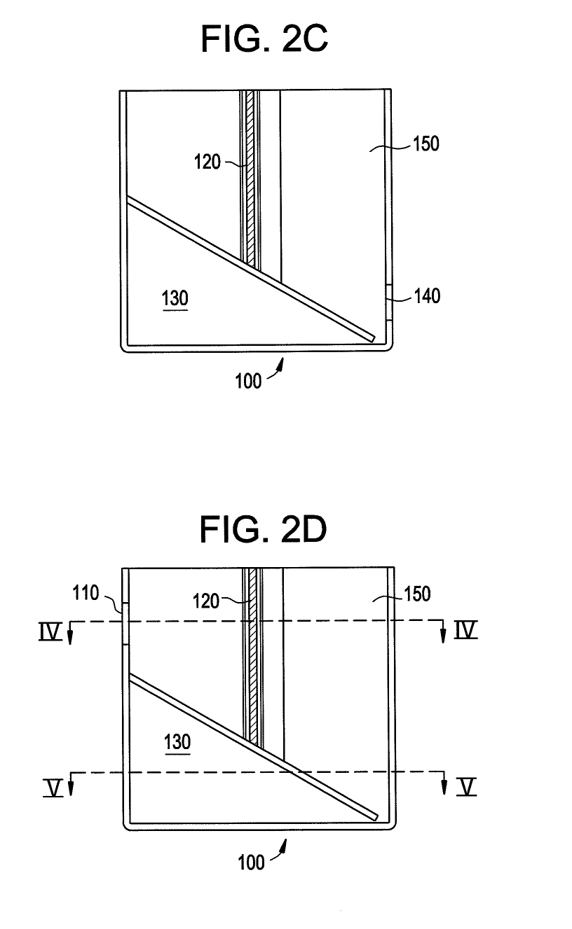

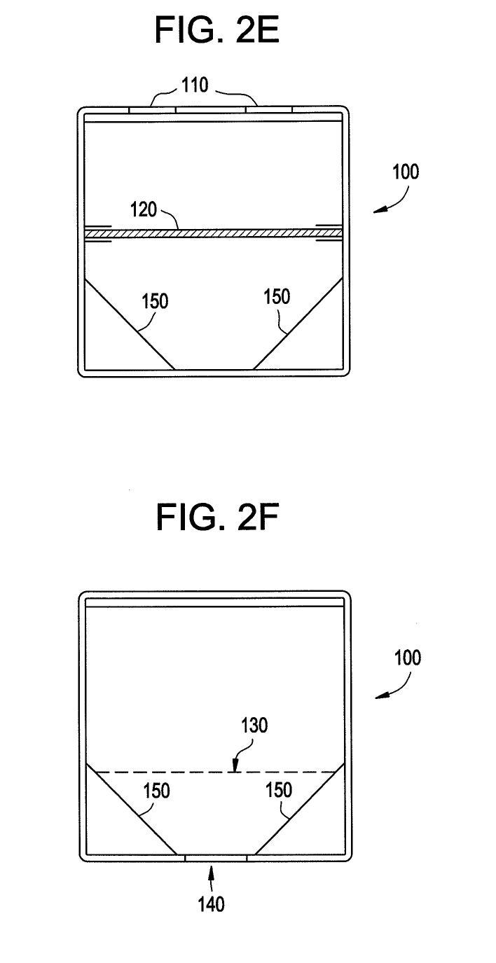

The combined mixing/filter chamber 100a, 100b is designed to ensure that no large agglomerations of material pass to a double acting positive displacement pump 5 that ultimately transports the grouts in parallel to a point of application and to ensure that the suspension of water and material are mixed as effectively as possible, thereby maximizing the distance over which the grouts may be pumped. The salient features of the combined mixing/filter chamber 100a, 100b are shown in FIGS. 2A-2F as now described in detail.

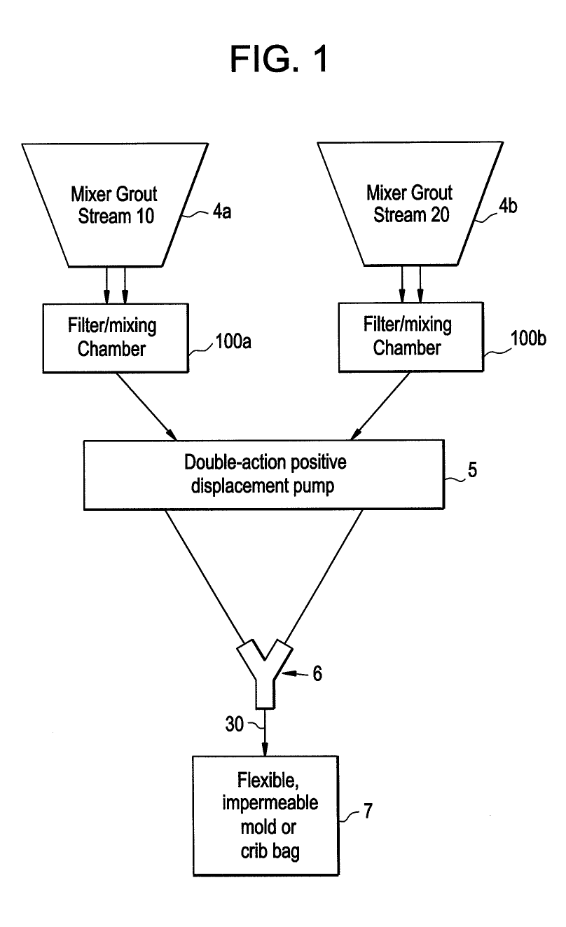

Each grout stream 10, 20 is transported through its own combined filter/mixing chamber 100a, 100b as illustrated in FIG. 1. However, for purposes of efficiency, only one of the chambers (hereinafter 100) is explained in detail. It is understood that each grout stream is transported independently and separately through its own chamber.

A combined mixing/filter chamber 100 has an internal geometry illustrated in FIGS. 2A-2F. Its dimension may be, for example, 10.4 inch (length)×10.4 inch (width)×10.0 inch (height); however, the present invention is not limited to these dimensions. The chamber may be formed of metal. In the present example, the grout stream enters the unit via two 2-inch diameter ports 110, the centre-points of which are located 7.5 inches above the base and 3 inches from each side of the chamber 100. The grout stream exits the unit via a single 2-inch diameter outlet port 140 which is centrally located 2.2 inches above a bottom of the unit. Both inlet and outlet ports 110, 140 are engineered to accommodate connection to the 1.25-inch diameter pipes normally used in such systems. The grout stream passes through a 0.375-inch mesh screen 120 installed across the centre of the unit; this prevents any agglomerations of material or foreign bodies reaching the pumps. In order to assist in the flow of material and also to provide some further mixing of the grout components, an internal base 130 of the chamber 100 is constructed at an angle of 45° from a point 2.15 inches below the centre point of the inlet ports 110 to a similar distance below the outlet port 140. Thus, in the present example, the internal base 130 is constructed at an angle of 45° from the bottom of the unit. However, the present invention is not limited to these dimensions and angle, as long as the inlets are relatively higher than the outlet and the internal base is angled to correspond with respective similar positions below and near the inlets and outlet in order to prevent dead spots within the interior of the chamber. Additionally, the two corners adjacent to the outlet port 140 are fitted with metal fillets 150 of triangular cross section such that they eliminate the right angled corners, effectively increasing these corner angles to 135°.

This geometry of the mixing/filter chamber 100 creates turbulence within an interior of the chamber, helping to ensure that the screen 120 does not become “blinded” by any material it traps, eliminates “dead-spots” where material can build up within the chamber and promotes further mixing of the grout components in each grout stream.

Two inlets 110 are generally preferable so that two pipelines can be fed into the chamber alternately. With this construction of two feeds, only one line is in operation at a time, but allows for continuous operation of the system. That is, if one line encounters problems, needs to be moved, etc., the alternate line can be used. Generally, however, only one line and thus, one inlet, is in use at any one time, per chamber.

The mixing/filter chamber 100 of the present invention is almost self-cleaning. Since almost all the dead spots in the cavity (interior) of the chamber are eliminated due to its novel geometry, the grout suspensions are thoroughly mixed and thus, less particles are caught in the mesh screen than would be found conventionally. For example, the angled bottom of the cavity provides the benefit of gravity to the mixing motion, the angled corners help eliminate dead spots, etc. thus improving the overall mixing effects of the mixing/filter chamber over the prior art.

However, in the event that the mesh screen does need to be cleaned, the top of the chamber is removable so that an operator can pull out the mesh screen and clean and replace it easily.

Thus, with the improved mixing of the inventive chamber, fewer interruptions are experienced during pumping because the chambers and pump do not encounter agglomerations found in conventional systems.

Referring back to FIG. 1, the pumping system transports equal volumes of the two slurries 10, 20 from their respective filter/mixing chambers along separate 1.25-inch diameter pipe-lines, almost to the point of discharge into a flexible, impermeable crib bag 7 suspended or supported from the roof of the mine. Just prior to the point of entry to the crib bag, the two grout streams are combined via a “Y” piece 6. Upon mixing together, the two grout streams begin to gel under the influence of the gelling agent, rapidly forming a self supporting gel within the crib bag. Pumping continues until the crib bag is completely filled. This is usually accomplished in three lifts. The structure becomes self-supporting within minutes and develops load bearing capacity within one hour.

The ratio of ordinary Portland cement to PFA or other pozzalanic materials may lie between 1:1 and 1:2 by weight. Satisfactory pumping performance can be achieved at overall water:solids ratios of between 1:1 and 1:2 by weight. It is possible to vary the proportions of all components used in the invention according to the particular requirements of the support system, or other installation, that is to be constructed.

### Example

Four water based grouts were prepared using the above method and used to fill two 6 feet by 30 inch diameter crib bags. The crib supports were stored for twenty-eight days and subsequently tested to assess their suitability for the purpose of underground roof support.

The in-duty requirements of roof support systems may be divided into three categories; a) stiffness, b) peak load capacity and c) residual loading capacity. In use, a support column is required to provide a high load bearing capacity combined with the ability to achieve that load with the minimum amount of compression of the support. The load bearing capacity must be such that it meets the requirements of the underground conditions particular to that installation and can be controlled to some extent by adjusting the diameter of the crib bags used to form the supports. As the day-to-day operation of the mine continues, the roof and floor of the mine tend to converge, increasing the load on the support. This results in the support being compressed further and the grout from which it is constructed begins to fracture. It is at this stage that the material and construction of the crib bag itself becomes important. It must provide sufficient containment for the hardened grout to be able to retain a residual load bearing capacity. The stiffness of the support may be defined as the maximum load bearing capacity in relation to the amount of vertical displacement or convergence of the support column observed at that maximum loading.

The National Institute for Occupational Safety and Health: Mining Research Laboratory (NIOSH) at Pittsburgh, Pa. has developed equipment and expertise to assess these characteristics. A full sized test crib support is subjected to increasing compressive load whilst simultaneous measurements of the compression or convergence of the test crib support are made. These tests are normally carried out 28 days after the production of the crib support.

Grouts (1 and 2) containing ordinary Portland cement (OPC) were produced and used in conjunction with a grout (1a and 2a) containing PFA and a gelling agent. Aluminum sulfate was manually incorporated into the PFA grout stream (1a) at the mixing stage as a finely divided crystalline material. Sodium aluminate was added manually to the PFA grout stream (2a) as a solution containing approximately 35-40% sodium aluminate and with a Na₂O/Al₂O₃ molar ratio of 1.5. The composition of the grouts is shown below in Table No. 1.

TABLE NO. 1

| Grout | % OPC | | | % Sodium | % Aluminum |
|---|---|---|---|---|---|
| No. | Type I | % PFA | % Water | aluminate* | sulfate |
| 1 | 50.0 | — | 50.0 | — | — |
| 1a | | 60.1 | 30.0 | 9.9 | — |
| 2 | 50.0 | | 50.0 | — | — |
| 2a | | 64.1 | 32.0 | — | 3.9 |

All quantities refer to percentage by weight.
(*refers to % addition of a 38% solution of sodium aluminate.)

Overall composition of the combined grout streams are shown in Table No. 2:

TABLE NO. 2

| | | | | Water:solids | % Sodium | % |
|---|---|---|---|---|---|---|
| Grout | % OPC | % | % | ratio (exc. | alumi- | Aluminum |
| No. | Type I | PFA | Water | gelling agent) | nate* | sulfate |
| 1/1a | 24.9 | 32.2 | 40.9 | 1:1.4 | — | 2.0 |
| 2/2a | 24.1 | 31.1 | 39.2 | 1:1.4 | 5.1 | — |

All quantities refer to percentage by weight.
(*refers to % addition of a 38% solution of sodium aluminate.)
Water temperature = 80° F. Ambient temperature = 50° F.

Equal volumes of OPC and PFA/gelling agent grouts were pumped into a flexible, impermeable, 30 inch diameter crib bag as described above. OPC grout composition 1 was combined with PFA/gelling agent composition 1a and OPC grout composition 2 was combined with PFA/gelling agent composition 2a. Prior to entering the double acting ram-pump each of the grout mixtures (1/1a and 2/2a) were passed through a combined filter/mixing chamber, respectively. The combined filter/mixing chamber was specifically designed to achieve maximum mixing and enhanced pumping characteristics utilizing the physical configuration discussed above and illustrated in FIG. 2. The two pumpable grouts 1/1a and 2/2a were then transported simultaneously along separate pipelines and combined at a “Y” piece in the pumping lines approximately six feet prior to entering the crib bag. Each combination of pumpable grout streams was used to fill two crib bags, three lifts being taken to fill each crib bag.

Observations were made as to the time taken for the combined grout streams to gel within the crib bag and also the time taken for the combined grout streams to become self-supporting within the crib-bag. The crib supports were then stored in the open air for approximately twenty-eight days before being tested.

Both combinations of material were observed to gel within 5 minutes and were self supporting within 15 minutes. Measurements relating to support load capacity and vertical displacement of the crib supports are shown below in Table No. 3. The data shown represents the average of the values obtained for each of the two pairs of crib supports produced.

TABLE NO. 3

| | | Vertical | Support load | Support load |
|---|---|---|---|---|
| | Peak support | displacement | (tons) at 3 | (tons) at 5 |
| Grout | load capacity | (inches) at peak | inches vertical | inches vertical |
| No | (tons) | load capacity | displacement | displacement |
| 1/1a | 156 | 0.9 | 102 | 98.5 |
| 2/2a | 266.5 | 0.9 | 137 | 115 |

These data compare favorably with the performance of crib supports produced by other pumped roof-support systems which, dependent upon the size of crib bag used, typically develop a peak load capacity of approximately 150 tons for a vertical displacement of 1 inch and a residual support capacity of approximately 75 to 50 tons at 5 or 6 inches of vertical displacement. Residual load capacity is largely influenced by the way in which the crib bag is able to restrain the fractured grout as it comes under increasing compressive load. However, the manner in which the grout fractures under load can also influence residual load capacity. Grout which fractures into sharp sections being more likely to cause ripping of the crib bag and thus loss of residual load capacity. It may be noted that the residual load capacity for the grouts of the invention was maintained for up to 5 or 6 inches of vertical displacement.

In addition, several other unexpected results were obtained by the grout mixture of the present invention. For instance, by incorporating the gelling agent in a mixture of PFA and water, a homogeneous mixture is achieved. This thorough mixing event in the process is fundamental in eliminating weak spots in the final structure. This benefit is not found in the prior art, which had a potential to create weak zones when unmixed pockets of gelling agent occurred as a result of inadequate mixing at the point of application. In contrast, the present invention is much more homogeneous which reduces the number of gel spots, i.e., weak spots in the final structure.

Another unexpected result of the grout of the present invention is that this combination of grout components works outside the normal temperature range for such systems. That is, the grout of the present invention will be pumpable at temperatures that were conventionally considered to be too cold. The grout of the present invention can be used below 34° F.

Thus, while conventional systems needed water heaters to maintain the temperatures over 34° F., the present invention can be utilized in areas having much lower temperatures.

The grouts of the present invention provide, when mixed in the appropriate proportions and used to fill a suitable mold, an effective method of producing a roof-support system. Since the grouts utilize OPC and PFA, both of which are readily available in the USA, there is a considerable economic benefit in this type of system over one based upon CSA or HA cements.

The novel grout mixture of the present invention utilizes conventional existing equipment used in the installation of pumped roof support systems. However, as noted above, an improved design for the filter and mixing chamber may be utilized in order to maximize the pumpable distance of the grout streams without incurring blockages.

The grouts of the present invention show comparable peak and residual load capacities to those obtained using other types of cements. Adjustments to factors such as the water:solids ratio and cement:pozzalan ratio can also be made to further influence load capacity in order to satisfy a specific roof support requirement or duty.

Various changes and modifications of the invention are possible such that it may be used for other purposes in underground mining operations without departing from the spirit and scope of the invention. These would include use in consolidating underground roadways, filling voids or cavities, and with the introduction of a foaming agent, the production of a lightweight grout.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A pumpable grout mixture comprising:
a first grout stream including a hydraulically active cementitious material suitable for cementing in underground applications and water; and
a second grout stream including a pozzalanic material and an inorganic gelling agent,
wherein the two grout streams are combined into a grout mixture to form a self-supporting load bearing structure.

2. A pumpable grout mixture according to claim 1, wherein the cementitious material is an ordinary Portland cement which conforms to any one of Types I, II, III, IV, V, Ia, IIa and IIIc.

3. A pumpable grout mixture according to claim 1, wherein the pozzalanic material is pulverized fuel ash (PFA).

4. A pumpable grout mixture according to claim 1, wherein the gelling agent is an alkali metal carbonate, alkali metal aluminate, aluminum sulfate or sodium silicate.

5. A pumpable grout mixture according to claim 4, wherein the gelling agent is between 1% and 8%, by weight, of the grout mixture.

6. A pumpable grout mixture according to claim 4, wherein the gelling agent is an alkali metal aluminate with Me₂O/Al₂O₃ molar ratio of between 1 and 2, wherein Me represents metal.

7. A pumpable grout mixture according to claim 6, wherein the gelling agent is approximately 35-40% solution of sodium aluminate.

8. A pumpable grout mixture according to claim 7, wherein the sodium aluminate gelling agent is between 2% and 8%, by weight, of a total composition of the grout mixture.

9. A pumpable grout mixture according to claim 4, wherein the gelling agent is aluminum sulfate.

10. A pumpable grout mixture according to claim 9, wherein the aluminum sulfate is between 1% and 3%, by weight, of a total composition of the grout mixture.

11. A pumpable grout mixture according to claim 1, wherein the overall water:solids ratio, excluding the gelling agent, of the grout mixture is between 1:1 and 1:2 by weight.

12. A pumpable grout mixture according to claim 3, wherein a ratio of ordinary Portland cement to PFA is between 1:1 and 1:2 by weight.

13. A combined filter and mixing apparatus, comprising:
a polygonal box shaped container;
an inlet port disposed on a first side of said container;
an outlet port disposed on a second side of said container, wherein said second side is opposite to said first side;
a mesh screen disposed in an interior of said container in an area between said inlet port and said outlet port;
a base disposed in the interior of said container, having an inclined surface extending from the first side to the second side of the container, wherein an upper portion of the inclined surface is disposed near the first side and the lower portion of the inclined surface is disposed near the second side;
triangular fillets disposed in two corners of the interior of said container, so as to form obtuse angled corners in the interior of said container.

14. The combined filter and mixing box apparatus according to claim 13, wherein the inlet port is a first inlet port and further comprises a second inlet port on the first side of the container, whereby the first inlet port and the second inlet port are used alternately.

15. The combined filter and mixing box according to claim 13, wherein the upper portion of the inclined surface intersects the first side of the container at an angle of approximately 45° below the inlet port, and the lower portion of the inclined surface intersects the second side of the container below the outlet port.

16. The combined filter and mixing box according to claim 13, wherein the mesh screen is provided across a center of the interior of the box so as to effectively divide the interior into two halves with the inlet port provided upstream of the mesh screen and the outlet port provided downstream of the mesh screen, when material is provided to the box via the inlet port.

17. A method of providing a pumpable grout for use in load bearing structures, comprising:
providing a first pumpable grout stream composed of an ordinary Portland cement and water;
providing a second pumpable grout stream containing PFA and an inorganic gelling agent and water;
transporting each of the first and second pumpable grout streams separately and simultaneously along separate pipelines;
conveying each of the first and second pumpable grout streams separately and simultaneously into a first and second filter/mixing chamber, respectively,
transporting each of the first and second pumpable grout streams separately and simultaneously into a double-action positive displacement pump, which pumps each of the first and second pumpable grout streams to a point of application wherein the separate grout streams are combined into a combined grout mixture,
wherein an overall water-to-solids ratio of the combined grout mixture is between 1:1 and 1:2 by weight;
wherein the ratio of Portland cement to PFA is between 1:1 and 1:2;
wherein the gelling agent is 1%-8% by weight of the combined grout mixture.

18. The method according to claim 18, wherein each of the first and second filtering and mixing chambers comprises:
an inlet port disposed on a first side of said chamber;
an outlet port disposed on a second side of said chamber, wherein the second side is opposite to the first side;
a mesh screen disposed in an interior of said chamber in an area between said inlet port and said outlet port;
a base disposed in the interior of said chamber, having an inclined surface extending from the first side to the second side of the chamber, wherein an upper portion of the inclined surface is disposed near the first side and the lower portion of the inclined surface is disposed near the second side;
triangular fillets disposed in two corners of the interior of said chamber, so as to form obtuse angled corners in the interior of said chamber,
wherein the first and second pumpable grout streams are further mixed, independently, in their respective filtering and mixing chamber so as to maximize a total distance over which the grout steams can be pumped without incurring blockages.
